(19) United States
(12) Patent Application Publication
(10) Pub. No.: US 2026/0213553 A1
(43) Pub. Date: Jul. 23, 2026

(54) ARRANGEMENT CONSISTING OF A POWER SUPPLY UNIT AND AT LEAST ONE BUFFER MODULE

(71) Applicant: Weidmüller Interface GmbH & Co. KG, Detmold (DE)

(72) Inventor: Matthias PLÖGER, Lemgo (DE)

(21) Appl. No.: 19/157,751

(22) PCT Filed: Feb. 29, 2024
(86) PCT No.: PCT/EP2024/055269

§ 371 Date: Aug. 19, 2025

(30) Foreign Application Priority Data
Mar. 6, 2023 (DE) 10 2023 105 479.1

(51) Int. Cl. H02J 7/34; H02J 1/08; H02J 7/50

(52) U.S. Cl. CPC H02J 7/345; H02J 1/084; H02J 7/50; H02J 2207/20; H02J 2207/50

(57) ABSTRACT

The invention relates to an arrangement consisting of a power supply unit and at least one buffer module having an electrical energy store, wherein the power supply unit has, in a common housing, an input-side rectifier, an input-side DC link having a DC link capacitor and an output side DC-to-DC voltage converter. The at least one buffer module is arranged in a separate housing, is electrically connected to the power supply unit and is used to buffer an output voltage of the power supply unit. The arrangement is distinguished by the fact that the buffer module is coupled to the input-side DC link of the power supply unit and, during operation, a DC link voltage of the DC link of the power supply unit is applied to the buffer module.

### BACKGROUND

The invention relates to an arrangement consisting of a power supply unit and at least one buffer module having an electrical energy store, wherein the power supply unit has, in a common housing, an input-side rectifier, an input-side DC link having a DC link capacitor, and an output side DC-to-DC voltage converter. The buffer module is arranged in an external housing and is electrically connected to the power supply unit and is used to buffer an output voltage of the power supply unit.

Power supply units of the type described, also known as switching power supply units, are used in a variety of ways to operate DC-powered devices on an AC voltage network. In particular in industrial uses, it is often required to be able to absorb (“buffer”) at least short interruptions in the mains voltage so that the operation of connected devices is not adversely affected by short-term interruption in the mains power supply. For cost reasons and to prevent the installation space and weight of a power supply unit from becoming too large, internal energy stores in the power supply unit are usually only provided in a size that allows buffer times in the range of a few milliseconds to a few tens of milliseconds.

In order to increase the buffer times when required, external buffer modules are connected in parallel to the output side of the power supply unit, these buffer modules have capacitors or rechargeable batteries as energy stores. To use with different power supply units and different output voltages or with power supply units with adjustable output voltages, such buffer modules usually have their own DC transformers. In addition, when using a capacitor as an energy store in the buffer module, a DC-to-DC voltage converter is always required in order to adapt the voltage of the capacitor, which changes as the charge decreases, to the DC voltage at the output of the power supply unit, which must be kept constant. The structure of the buffer modules is therefore complex both electrically and with regard to costs.

The “SITOP PSU8600” from Siemens is a power supply system in which a basic device-the actual power supply unit-can be coupled with external modules that increase a buffering time in the event of a power failure. The power supply is constructed in three stages and comprises an input-side rectifier (first converter stage), an input-side DC link and two DC-to-DC voltage converters connected in series (second and third converter stages), with the two DC-to-DC voltage converters being coupled via a further DC link. The external modules can contain capacitors or batteries that are connected in parallel to the output-side further DC link of the power supply unit. Depending on the application, a power supply unit can advantageously be supplemented with a desired buffer capacity, with the second, output-side DC-to-DC voltage converter being advantageously used to provide a constant DC voltage at the output of the power supply unit even when the voltage of the buffer module changes upon discharging.

Thus there is a need for an arrangement consisting of a power supply unit and at least one buffer module with an energy store, in which the buffer module can be used without an additional DC-to-DC voltage converter to provide a constant output voltage and can be used in conjunction with a power supply unit that does not have a three-stage structure with two DC-to-DC voltage converters.

### SUMMARY OF THE INVENTION

Accordingly, it is an object of the present disclosure to provide an arrangement wherein the buffer module is coupled to the input-side DC link of the power supply unit and, during operation, a DC link voltage of the input-side DC link of the power supply unit is applied to the buffer module.

In the arrangement according to the invention the buffer module is not coupled to the power supply unit on the output side or at the additional output-side DC link, but is electrically connected to the input-side DC link of the power supply unit. Accordingly, the buffer module operates with the input-side DC link voltage, which is substantially independent of the output voltage of the power supply unit. The input-side DC link voltage is usually determined only by the mains voltage, the number of mains phases used (power supply unit powered by a single phase versus three phases), and any power factor correction filter (PFC) which may be present. Within a country or a region, the mains voltage is constant, which means that many different types of power supply units, regardless of their output voltage, have comparable DC link voltages to which the electric strength of the energy store can then be adapted.

In the case of the mains voltage of 230 volts (V) which is common in Europe, the input-side DC link voltage after rectification of the mains voltage is around 325 V (slightly higher for power supply units with Power Factor Correction filters). It has been shown that capacitors, particularly electrolytic capacitors, that are suitable for this voltage range, i.e. capacitors with an electric strength of around 380-450 V, have a particularly low energy-specific volume, i.e. have a particularly high maximum energy density. For a given volume of the buffer stores, a longer buffering time can be achieved than when using capacitors with a lower electric strength that are connected in parallel to the output-side DC link or the output voltage.

In an advantageous embodiment of the arrangement, the energy store of the at least one buffer module is at least one capacitor and/or at least one rechargeable battery. Capacitors can be charged and discharged quickly and require little maintenance. They are particularly suitable as short-term buffer stores. Rechargeable batteries can also be used to buffer longer power failures due to their high capacity.

In an advantageous configuration of the arrangement, a connection between the power supply unit and the at least one buffer module comprises an energy bus. The at least one buffer module advantageously has a switching unit via which the energy store is connected to the energy bus, as a result of which the connection between the power supply unit and the energy store can be controlled. For this purpose, the switching unit can have at least one semiconductor switching element in order to couple the energy store to, or disconnect it from, the energy bus. More preferably, different current paths are provided for charging and discharging the energy store.

By appropriately controlling the switching element accordingly, a charging voltage for the energy store can be limited to a specified maximum value. In addition, current peaks can be prevented that could otherwise occur, for example, if a buffer module is connected to a power supply unit during operation. Ripple currents can also be reduced, which has a positive effect on the service life of the energy store.

In a further advantageous configuration, the arrangement comprises a data bus and/or signal bus between the power supply unit and the at least one buffer module. The at least one buffer module preferably has a control unit which is coupled to the data and/or signal bus and controls the switching unit. Information can be exchanged between the power supply unit and the at least one buffer module via the data and/or signal bus such that use of the at least one buffer module can be optimized.

In a further advantageous configuration of the arrangement, the control unit is designed to control at least one semiconductor switching element of the switching unit in a pulse width modulation method. The control unit is preferably configured to regulate a charging and/or discharging current of the energy store. In this way, the limitations of charging voltage and/or charging current for the energy store can be implemented.

In a further advantageous configuration of the arrangement, the control unit is designed to transmit information about the at least one buffer module to the power supply unit and/or a higher-level control device via the data and/or signal bus. The transmitted information can be status information about the state (operating state, ageing state, etc.) of the energy store and/or the switching unit. The power supply unit can then advantageously adapt the use of the buffer module to its state.

In a further advantageous embodiment of the arrangement, the at least one buffer module has options for connecting a further buffer module. As a result, buffer modules can be interlinked and the buffer capacity can be increased simply by adding further buffer modules. Due to the interlinking, only one connection option for a buffer module is required on the power supply unit itself.

### BRIEF DESCRIPTION OF THE DRAWINGS

The invention will be explained in greater detail below using an exemplary embodiment with the aid of three figures. In the figures:

FIG. 1 shows a schematic block diagram of an arrangement consisting of a power supply unit and two buffer modules;

FIG. 2 shows a detailed schematic block diagram of one of the buffer modules according to FIG. 1; and

FIG. 3 shows a schematic circuit diagram of the buffer module according to FIG. 2.

### DETAILED DESCRIPTION

The power supply unit 1 has an alternating-current voltage input 2, with which it can be connected to an alternating voltage current supply network during operation. The alternating-current voltage input 2 can be single-phase, i.e. have two conductors, or three-phase and accordingly comprise three conductors and possibly a neutral conductor.

In the power supply unit 1, the alternating current voltage from the alternating-current voltage input 2 is fed to a rectifier 3, also referred to as an AC/DC converter (AC—Alternating Current; DC—Direct Current). The rectifier 3 can be configured to be purely passive and only have a diode arrangement. The rectifier 3 usually has actively controlled switching elements in order to reduce distortion power factors and thus disruptive harmonics in the network. This is known as a power factor correction filter (PFC—Power Factor Correction).

A DC link 4, which substantially comprises one or more DC link capacitors connected in parallel, is arranged at the output of the rectifier 3. Downstream of the DC link 4, there is connected a DC-to-DC voltage converter 5, also called a “DC/DC converter”, which converts the DC link voltage into a direct current voltage of the desired level, which is provided at an output 6 of the power supply unit 1 to supply consumers. With the rectifier 3 (AC/DC converter) and the DC-to-DC voltage converter 5 (DC/DC converter), the power supply unit 1 thus has a two-stage structure.

The level of the DC link voltage depends on the mains voltage when using a passive rectifier and, in the case of a single-phase power supply unit that is supplied with 230 V of alternating current, is approximately 325 V. As a rule, power supply units are designed for lower output voltages at the direct current voltage output 6, such that a possibly galvanically isolating topology with a step-down effect, in the simplest case a step-down converter, is used as the DC-to-DC voltage converter 5. Such a step-down converter loads its input with a pulsed input current. The DC link 4 with its DC link capacitors is used to provide pulsed current at the alternating-current voltage input 2, independently of the current phase position of the supplied mains voltage.

The components of the power supply unit 1, in particular the DC-to-DC voltage converter 5 and the PFC stage of the rectifier 3, are controlled and monitored by a power supply unit control device 7.

In addition to the alternating-current voltage input 2 and the direct current voltage output 6, an energy bus 8 and optionally also a data and/or signal bus 9 is led out of the housing of the power supply unit 1, to which a first of the buffer modules 10 is connected. As indicated by the capacitor symbol on the buffer module 10, the buffer module 10 has an energy store that is connected to the DC link 4 via the energy bus 8. For example, the energy store of the buffer module 10 can be a capacitor or an arrangement of several capacitors that are connected via the energy bus 8 in parallel to the capacitor of the DC link 4. The energy bus 8 is in this case formed by two lines with corresponding current-carrying capacity.

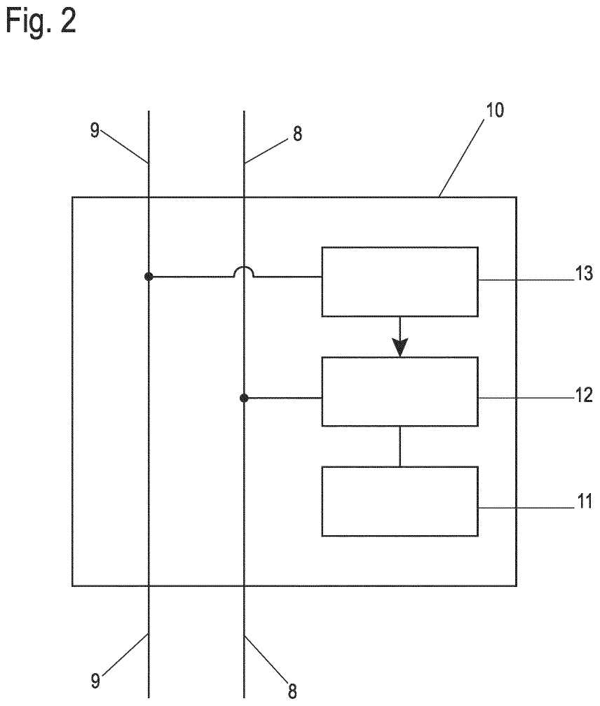

Preferably, connectors are formed on the power supply unit 1 and/or on the buffer module 10 so that the energy bus 8 and the data and/or signal bus 9 can be connected or disconnected in a simple manner. In particular, in the case of the energy bus 8, a corresponding electric strength of the insulation and also anti-contact protection are provided due to the high voltages present. The data and/or signal bus 9 can be used to control the buffer module 10 or its connection to the power supply unit 1, as will be explained in more detail below in connection with FIG. 2.

As a special design of plug-and-socket connector, so-called cross connectors can also be used, especially when the power supply unit 1 and buffer module 10 are configured as devices that can be snapped onto a mounting rail next to each other. Plug-in elements of the cross connectors are plugged in a bridging manner with correspondingly adjacent plug-in openings in the housings of the power supply unit 1 and the buffer modules 10 are plugged in. A corresponding electric strength of the insulation and also anti-contact protection are provided.

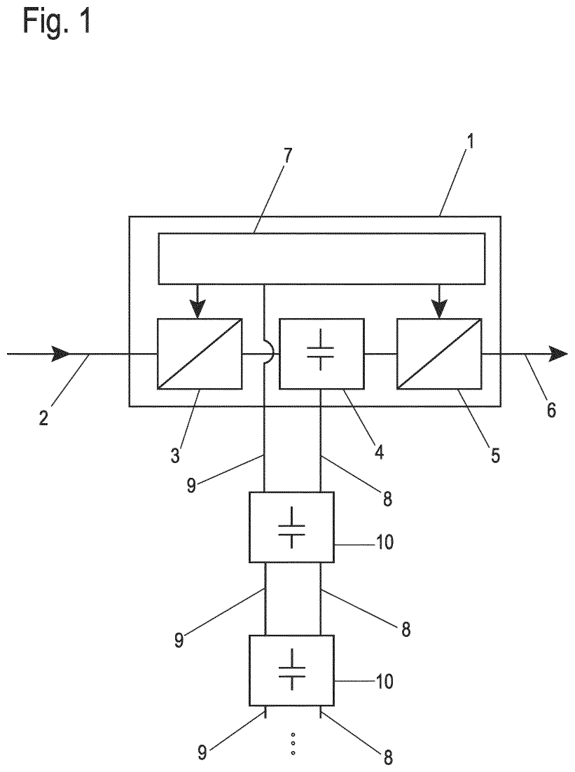

As shown in the example in FIG. 1, it can be envisaged that the energy bus 8 and the data and/or signal bus 9 are passed on from the first buffer module 10 in the form of plug-and-socket connectors found on the power supply unit 1 so that one or more further buffer modules 10 can be interlinked in series as required. By way of example, a continuous data and/or signal bus 9 is shown in FIG. 1. However, it is also conceivable that in each case a point-to-point connection between adjacent devices is implemented in the data and/or signal bus 9.

Both the power supply unit 1 and the buffer modules 10 can be arranged in housings that are configured to be snapped onto a mounting rail. Alternatively or additionally, mounting means can be provided for direct mounting, e.g. on a mounting plate.

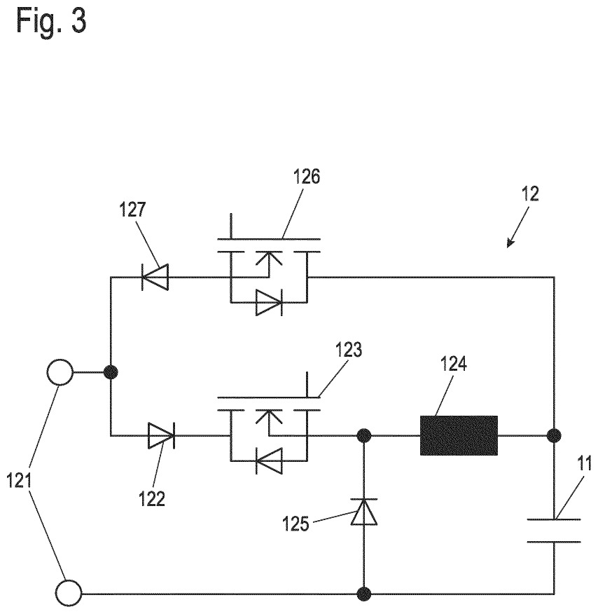

FIG. 2 depicts a structure of a buffer modules 10 according to FIG. 1. It comprises an energy store 11, for example one or more capacitors, and in particular electrolytic capacitors. In further configurations, rechargeable batteries and/or so-called high-capacity “super caps” or “gold caps” can alternatively or additionally be used as energy stores. The energy store 11 is connected to the energy bus 8 via a switching unit 12. The switching unit 12 can, for example, comprise semiconductor switches or a relay in order to connect the energy store 11 to the energy bus 8 in a selective and controlled manner. An exemplary embodiment of a switching unit 12 is shown in FIG. 3 and is explained in greater detail below. For control purposes, a control unit 13 is provided which receives control signals or control data from the data and/or signal bus 9. Furthermore, parameters from the power supply unit 1 or its power supply control device 7 can be transmitted from a higher-level control unit to the buffer module(s) 10 in order to adjust its/their operating behavior. Alternatively or additionally, information for controlling the buffer module can be derived from a voltage state of the energy bus 8. In addition, it can be envisaged that status information, for example about the state (operating state, environmental parameters, e.g. temperature, ageing state, etc.) of the energy store 11 and/or the switching unit 12, is transmitted to the power supply unit 1, or its power supply control device 7 and, if necessary, also to a higher-level control device.

The energy store 11 can be decoupled from the energy bus 8, for example, via the switching unit 12 if there is no connection to a power supply unit 1. This prevents a potentially high operating voltage of the energy store 11 from being present on the energy bus 8 while its connections are open because they are not connected to the power supply unit 1. This also prevents high compensating currents from flowing directly between the DC link 4 and the energy store 11 when the buffer module 10 is connected to the power supply unit 1, if they are charged to different voltages. It can be envisaged, for example, that a connection is made only when the DC link 4 and the energy store 11 both have substantially the same voltage, such as when both are discharged.

In particular, if the switching unit 12 has a semiconductor switch as a switching element, it can also be envisaged to regulate a charging or discharging current of the energy store 11 after connecting the buffer module 10 to the power supply unit 1 to reduce it so that no excessively large charging or discharging currents flow. The maximum level of a charging or discharging current represents a parameter which can be transmitted from the power supply unit 1 or its power supply unit control device 7, or a higher-level control unit to the buffer module(s) 10.

Control of the charging or discharging currents can be carried out by means of a corresponding pulse width modulation of the switching element of the switching unit 12. In a further embodiment, the switching unit 12 can also be provided with a discharging option for the energy store 11 to discharge it before disconnecting it for safety reasons.

Furthermore, the switching module 12 can be used advantageously to switch the energy store 11 on only when the power supply unit 1 signals a corresponding need. The number of charging and discharging cycles as well as a ripple current load on the energy store 11 can thus be reduced, thereby increasing its service life.

The functions mentioned can be controlled by the control unit 13, if necessary in communication with the power supply control device 7. In addition, monitoring functions can be implemented in the control unit 13, for example to ascertain the charging state such the charging voltage of the energy store 11 and to display it on the buffer module 10 using a corresponding signaling unit and/or to transmit it to the power supply unit 1 via the data and/or signal bus 9. The control device 13 can also be provided with an operating time or charging cycle recordal for the energy store 11, since this information provides information about the ageing state of the energy store 11. This is useful with regard to operational reliability and/or predictive maintenance. It is also possible to ascertain the ageing state in this way using measurement technology.

The coupling of the energy store 11 to the DC link 4 has the advantage that a falling voltage of the energy store 11 during discharging does not have to be compensated by an additional DC/DC converter, but is compensated to a certain extent inherently by the DC/DC converter 5 of the power supply unit 1. A further advantage is that energy flowing back from the output 6 via the DC-to-DC voltage converter 5, which can occur when motors are connected to the power supply unit 1 in a generator operating state and the DC converter 5 of the power supply unit 1 can work bidirectionally, can be absorbed by the energy store 11 and does not have to be converted into heat energy. This requires a corresponding electric strength of the DC link, which is above the nominal DC link voltage.

FIG. 3 schematically shows an advantageous configuration of a switching unit 12 together with an energy store 11, as can be used in the buffer module 10 depicted in FIG. 2.

The switching unit 10 is connected to the energy bus 8 via connections 121. In the example shown, the energy store 11 is designed as a capacitor and will also be referred to below as capacitor 11.

A peculiarity of the switching unit 12 shown in FIG. 3 is the two different current paths between the capacitor 11 and the energy bus 8, with a first current path being configured for the defined charging of the capacitor 11 and a second current path being configured for the defined discharging of the capacitor 11.

The first path comprises a series circuit consisting of a diode 122, a semiconductor switching element 123 and a coil 124. In addition, a free-wheeling diode 125 is arranged in parallel to the serial connection consisting of the coil 124 and the capacitor 11. In this way, a controllable step-down converter is formed when the semiconductor switching element 123 is controlled in a clocked manner. For example, a MOSFET (Metal Oxide Semiconductor Field-Effect Transistor) or an IGBT (Insulated Gate Bipolar Transistor) can be used as the semiconductor switching element 123.

By appropriately controlling the semiconductor switching element 123, a charging voltage for the capacitor 11 can be limited to a specified maximum value. In addition, current peaks can be prevented that could otherwise occur if a buffer module 10 is connected to a power supply unit 1 during operation. Ripple currents can also be reduced using a step-down converter, which increases the service life of the capacitor 11. Since a charging of the capacitor 11 can take place in a controlled manner with comparatively low currents, the specified components of the first path do not need to be designed for high performance, which makes them cost-effective.

A semiconductor switching element 126 and a diode 127 are also arranged in the second current path used for discharging. The semiconductor switching element 126 can, for example, be a MOSFET or an IGBT. The semiconductor switching element 126 is advantageously designed for a higher current to be transmitted in order to be able to provide a possibly required high current of the power supply unit 1 in the event of buffering.

The semiconductor switching element 126 enables a defined release of the energy stored in the capacitor 11. The current directions in the charging path and discharging path are defined by the two diodes 122 and 127. The diode 122 prevents unintentional discharging if the voltage up to which the capacitor 11 is charged is greater than the voltage applied to the connections 121. Conversely, the diode 127 prevents unintentional or uncontrolled charging of the capacitor 11. A further advantage of the separate charging and discharging paths is that the energy from the capacitor 11 does not have to be transferred back via the coil 124, which could possibly lead to overshoots and would require a low internal resistance for the coil 124 and thus a larger wire cross-section.

As an alternative to using a controllable step-down converter, a linear regulator could also be used to limit charging of the capacitor 11 to a defined voltage. The advantage of this is that less electromagnetic contamination occurs because there is no clocked semiconductor switching element. The disadvantage is increased power loss in the linear regulator.

1. An arrangement comprising a power supply unit and at least one buffer module having an electrical energy store, the power supply unit having an input-side rectifier, an input-side DC link having a DC link capacitor and an output side DC-to-DC voltage converter in a common house, the at least one buffer module being arranged in a separate housing, being electrically connected to the power supply unit and being used to buffer an output voltage of the power supply unit, wherein the buffer module is coupled to the input-side DC link of the power supply unit and a DC link voltage of the DC link of the power supply unit is applied to the buffer module during operation.

2. The arrangement according to claim 1, wherein the energy store of the at least one buffer module includes one of at least one capacitor, at least one rechargeable battery, and both at least one capacitor and one rechargeable battery.

3. The arrangement according to claim 1, wherein a connection between the power supply unit and the at least one buffer module comprises an energy bus (8).

4. The arrangement according to claim 3, wherein the at least one buffer module has a switching unit via which the energy store is connected with the energy bus (8).

5. The arrangement according to claim 4, wherein the switching unit has at least one semiconductor switching element to couple the energy store to or disconnect it from the energy bus.

6. The arrangement according to claim 4, wherein the switching unit has different current paths for charging and discharging the energy store.

7. The arrangement according to claim 3, wherein the connection between the power supply unit and the at least one buffer module comprises at least one of a data bus and a signal bus.

8. The arrangement according to claim 4, wherein the at least one buffer module has a control unit coupled to one of the data bus and signal bus to control the switching unit.

9. The arrangement according to claim 8, wherein the control unit controls at least one semiconductor switching element of the switching unit in a pulse width modulation method.

10. The arrangement according to claim 9, wherein the control unit is configured to regulate at least one of a charging and discharging current of the energy store.

11. The arrangement according to claim 8, wherein the control unit is designed to transmit information about the at least one buffer module to the power supply unit via at least one of the data bus and signal bus.

12. The arrangement according to claim, wherein the at least one buffer module is configured to connect a further buffer module.
